(19) United States
(12) Patent Application Publication
(10) Pub. No.: US 2005/0013892 A1
(43) Pub. Date: Jan. 20, 2005

(54) Process and apparatus for combining virgin material and reground material

(76) Inventors: Perry Christopher Downs, Ware (GB); Kenneth Asheley Green, Ware (GB); William James Nicholson, Wokingham (GB)

Correspondence Address: DAVID J LEVY, CORPORATE INTELLECTUAL PROPERTY;GLAXOSMITHKLINE, FIVE MOORE DR., PO BOX 13398, RESEARCH TRIANGLE PARK, NC, 27709-3398, US

(21) Appl. No.: 10/498,592

(22) PCT Filed: Dec. 17, 2002
(86) PCT No.: PCT/GB02/05716

(30) Foreign Application Priority Data
Dec. 17, 2001 (GB) 0130131.6

(51) Int. Cl. B29C 43/02

(52) U.S. Cl. 425/352; 425/217

(57) ABSTRACT

A semi-automated apparatus and process for combining virgin blend material and reground tablet material, said apparatus comprising: (a) a chamber including an inlet for said virgin blend material; (b) a hopper including an inlet for said reground tablet material; and (c) a feeder for feeding said reground tablet material from said hopper to said chamber for combining with said virgin blend material, wherein said feeder controls the rate of feeding to said chamber.

The present invention relates to the preparation of pharmaceutical tablets, and more particularly to a semi-automated apparatus and process for combining virgin blend material and reground tablet material.

The use of conventional ‘compression technology’ in the manufacture of pharmaceutical tablets provides a simple and effective approach to mass production, that has found widespread utility within the pharmaceutical industry. In a typical production facility the pre-ground tablet composite material (hereinafter “virgin blend”) is fed via an enclosed system into a hopper, wherein it is passed through a powder feeder and onto a die table prior to compression.

It is widely acknowledged that performance of the aforesaid process leads to the generation of waste material both before and after compression of the virgin blend has taken place. Such wastage is of both environmental and economic concern since it is seldom recoverable and requires careful disposal upon collation. In particular, the high production costs of raw pharmaceutical composite materials (particularly the active ingredients themselves) means that the development of convenient ways to minimise the waste, or the ability to recycle it, are considered highly desirable by those in the field.

For example, it is inherent to most conventional tablet presses that an accumulation of blend dust occurs around the turret and external periphery of the machine. Generally, this dust is collected by the use of a cyclone dust collector system associated with the tablet press itself. Following completion of the manufacture of a given tablet batch, the accumulated dust in the dust collector system is typically weighed, recorded as waste and transported to a remote location for incineration. Although this method is effective in removing blend dust from the environment of the tablet press it results in the loss of valuable tablet blend material.

WO 96/37360 (GlaxoWellcome Inc.) describes one approach to this problem by the use of an automated blend reclaim system, which uses a compressed air/vacuum extraction mechanism to facilitate reintroduction of the blend material into the tablet press.

It will be apparent to those skilled in the art that a significant proportion of virgin blend material is lost from the above-mentioned tablet compression process owing to the formation of tablet rejects. Tablet rejects are those tablets which are deemed not to possess the physical characteristics (e.g. hardness or friability) required to meet the Product Quality Specification (PQS), and as such are routinely disposed of as waste. Such rejects may be classified in accordance with the stage of the manufacturing procedure at which they are generated. For example, “start-up rejects” are those rejects generated as a result of the need to meet specific manufacturing parameters associated with the tabletting process (e.g. tablet weight), prior to bulk batch production. “Running rejects” are those rejects automatically generated during the course of batch production as a result of a particular tablet composition falling above or below the pre-determined requisite production parameters (as programmed into the tablet compression machine).

The total quantity of tablet rejects derived from a given batch of virgin blend material is ultimately dependent upon the nature of the batch composition. However, for initial batch weights of between 150 and 300 kg one might typically expect to generate between 0.5 and 5 kg of start-up rejects and between 5 and 8 kg of running rejects. Although it is possible to keep the number of tablet rejects produced to a minimum by maintaining optimal operating conditions, a significant proportion of them are perceived to be inherent to the compression process and are therefore deemed unavoidable. It will be appreciated that the quantities of virgin blend material routinely lost as a result of the generation of tablet rejects equates to a substantial cost burden. Thus, there exists a long felt need to provide a method and/or apparatus which may be utilised in conjunction with the aforesaid compression process to effect recycling of the reject tablet material during the course of tablet manufacture.

It has now been discovered that tablet rejects produced as a result of tablet compression processes may be reground (hereinafter “reground tablet material”) and subsequently admixed with virgin blend material, in accordance with the description below, to provide an efficient means for the preparation of pharmaceutical tablets.

The term “reground tablet material” will be understood to comprise that material obtained from the milling of tablet rejects. Such milling processes will be readily apparent to those skilled in the art and may be effected by the use of conventional technology, for example, a pin mill or high-speed hammer mill.

According to one aspect of the present invention there is provided an apparatus for combining virgin blend material and reground tablet material comprising:
(a) a chamber including an inlet for said virgin blend material;
(b) a hopper including an inlet for said reground tablet material; and
(c) a feeder for feeding said reground tablet material from said hopper to said chamber for combining with said virgin blend material,
   wherein said feeder controls the rate of feeding to said chamber.

According to a second aspect of the present invention there is provided an apparatus for preparing a tablet wherein said chamber communicates with a tablet compression machine. It will be appreciated that said chamber will preferably communicate with said tablet compressor via a powder feeder.

Suitable tablet compressors for the preparation of pharmaceutical tablets will be readily apparent to those skilled in the art and may include, for example, the Manesty Rotapress™ or Manesty Betapress™ tablet compression machines.

In a preferred embodiment of the present invention said hopper communicates with a sealable chamber which may optionally have one or more valves attached thereto. Said sealable chamber is intended to provide an enclosed area into which reground tablet material may be placed to effect controlled addition of said reground tablet material into said hopper. It will be appreciated by those skilled in the art that reversible communication between said sealable chamber and said hopper may be achieved by use the of, for example, a conventional triclamp. Where present, said valve or valves are preferably conventional slide valves. Said valve or valves is/are intended to provide a means for allowing controlled addition of said reground tablet material to said hopper.

In a further preferred embodiment of the present invention said feeder engages in perpendicular relationship with said inlet for said virgin blend material. Said perpendicular relationship has been found to provide a particularly effective means of combining said virgin blend material with said reground tablet material, by encouraging mass-flow within said chamber. More preferably, said feeder engages in perpendicular relationship with said feed inlet for said virgin blend material at the uppermost position thereof.

It will be appreciated that said feeder is intended to provide an automated means of transporting reground tablet material from said hopper to said chamber. The rate of feeding may be controlled by pre-setting the feeder rate, thereby enabling the operator to effectively control the amount of reground tablet material to be combined with the virgin blend material. Suitable feeders include, for example, a vibratory feeder, piston feeder, or screw feeder. Preferably, said feeder is a screw feeder, such as a twin screw feeder. More preferably said feeder is a variable speed screw feeder.

It will be further appreciated that the present invention is intended to include an apparatus having any combination of the preferred embodiments as listed hereinbefore.

According to a third aspect of the present invention there is provided a process for combining virgin blend material and reground tablet material, comprising feeding said reground tablet material to said virgin blend material for combining therewith, characterised by controlling the rate of feeding.

It will be appreciated that the powder composition obtained from combining said virgin blend material and reground tablet material will be suitable for direct use in a tablet compressoin machine for the preparation of tablets. Thus, according to a fourth aspect of the present invention there is provided a process for preparing a tablet comprising combining virgin blend material and reground tablet material according to the third aspect of the present invention, and thereafter compressing the resulting composition into tablet form.

Preferably the rate of feeding of said reground tablet material is in the range from 0.1 to 4.01 hr⁻¹. More preferably the rate of feeding of said reground tablet material is in the range from 0.5 to 1.51 hr⁻¹. It will be appreciated that the rate of feeding of reground tablet material is preferably controlled by a screw feeder as hereinbefore defined. Preferably the rate of feeding is such that said reground tablet material and said virgin blend material enter a chamber simultaneously.

Preferably said reground tablet material has a number average particle size distribution that equates to the observed size range of the virgin blend material with which said reground tablet material is combined.

Preferably the ratio of said reground tablet material to said powdered virgin blend material in the final tablet formulation does not exceed 1:10 (<10%). Whilst it will be appreciated that compositions lying within the aforesaid ratio are considered preferable, the actual ratios employed may be varied in accordance with local Regulatory requirements for a given tablet type.

Preferably said reground tablet material and said virgin blend material are of substantially the same composition. By substantially the same composition it is meant that both said reground tablet material and said virgin blend material contain a quantity of active ingredient(s) within 5% w/w of each other, more preferably within 3% w/w of each other, most preferably both species will contain identical quantities of active ingredient(s) and, where appropriate, excipients (such as binding agents, fillers, lubricants, disintegrants and/or wetting agents).

According to a fifth aspect of the present invention there is provided a tablet obtainable by a process as hereinbefore described.

According to a sixth aspect of the present invention there is provided an apparatus substantially as herein described with reference to the drawings and/or examples.

According to a seventh aspect of the present invention there is provided a process substantially as herein described with reference to the drawings and/or examples.

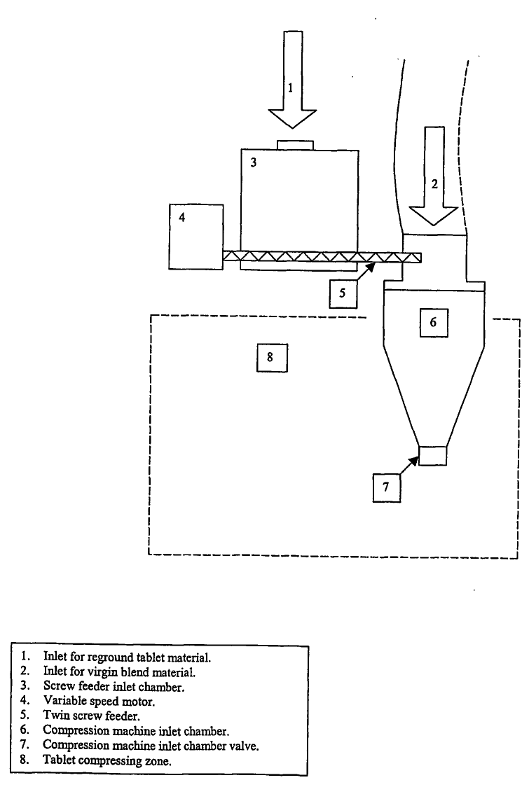

The present invention will now be described with reference to the accompanying drawing, FIGURE. 1, which provides a schematic representation of a preferred embodiment of the present invention.

With reference to FIG. 1, there is provided an inlet for reground tablet material (1) adjoining a screw feeder inlet (3), wherein said screw feeder inlet (3) provides for controlled addition of reground tablet material into a twin screw feeder (5). The speed at which the twin screw feeder (5) rotates is controlled by a variable speed motor (4). Reground tablet material is moved by the twin screw feeder (5) towards a compression machine inlet chamber (6). On entering said compression machine inlet chamber (6) reground tablet material is admixed with virgin blend material which is introduced via the inlet for virgin blend material (2). The reground tablet material and virgin blend material pass through the compression machine inlet chamber valve (7) into the tablet compressing zone (8). The tablet compressing zone typically comprises a tablet compression machine, such as those described hereinbefore.

### EXAMPLE 1

Active Combivir™ tablets (300 kg) were milled at <2000 r.p.m. using a Y-TRON Quadro197A Comil equipped with a grated 50G screen and a 0.200” (5 mm) spacer. A known quantity (3 kg) of the reground tablet material was added to a batch of active Combivir™ virgin blend material, using the process according to the present invention. The resulting blend of reground and virgin blend tablet material was subsequently compressed into tablet form using a Fette PT2090 TSC rotary tablet compression machine fitted with Combivir™ shaped tooling. The resulting tablets were sampled and tested for the content uniformity of the active ingredients Lamivudine™ and Zidovudine™. Impurity testing was performed before and after milling, and a dissolution profile was generated on the coated tablets.

| Time/Minutes | mg/tablet (Lamivudine ™) | mg/tablet (Zidocudine ™) |
|---|---|---|
| 0 | 0 | 0 |
| 1 | 0 | 0 |
| 2 | 0 | 0 |
| 3 | 0 | 0 |
| 4 | 0.7 | 1.3 |
| 5 | 4.9 | 8.4 |
| 6 | 5.0 | 8.1 |
| 7 | 5.1 | 8.7 |
| 8 | 7.1 | 12.1 |
| 9 | 5.6 | 9.7 |
| 10 | 6.1 | 10.3 |
| 11 | 6.9 | 11.8 |
| 12 | 6.0 | 9.8 |
| 13 | 5.8 | 9.3 |
| 14 | 4.2 | 7.1 |
| 15 | 1.3 | 2.4 |
| 16 | 0.8 | 1.3 |
| 17 | 0.2 | 0.4 |
| 18 | 0.1 | 0.2 |
| 19 | 0.1 | 0.1 |
| 20 | 0.2 | 0.3 |
| 21 | 0.1 | 0.1 |
| 22 | 0.1 | 0.1 |
| 23 | 0 | 0.1 |
| 24 | 0 | 0.1 |
| 25 | 0 | 0 |

[image]

### CONCLUSION

The results presented above illustrate that a near uniform proportion of Lamivudine™ and Zidovudine™ was found to be present in any given Combivir tablet at any given time. The ratio of Lamivudine™ to Ziduvudine™ throughout the course of the experiment was found not to deviate from that observed in a typical active Combivir™ sample, suggesting that the readdition process was successful. Impurity analyses of samples obtained before, during and after the run showed impurity levels that were in accordance with those observed for a typical active Combivir™ sample.

1. An apparatus for combining virgin blend material and reground tablet material comprising:
(a) a chamber including an inlet for said virgin blend material;
(b) a hopper including an inlet for said reground tablet material; and
(c) a feeder for feeding said reground tablet material from said hopper to said chamber for combining with said virgin blend material,
wherein said feeder controls the rate of feeding to said chamber.

2. An apparatus for preparing a tablet according to claim 1, wherein said chamber communicates with a tablet compression machine.

3. An apparatus according to any preceding claim 1 wherein said hopper communicates with a sealable chamber.

4. An apparatus according to claim 3 wherein said sealable chamber has one or more valves connecting thereto.

5. An apparatus according to claim 1, wherein said feeder engages in perpendicular relationship with said inlet for said virgin blend material.

6. An apparatus according to any preceding claim 1, wherein said feeder engages in perpendicular relationship with said inlet for said virgin blend material.

7. An apparatus according to claim 6 wherein said feeder engages with said inlet at the uppermost position thereof.

8. An apparatus according to any preceding claim, wherein said feeder is a screw feeder.

9. An apparatus according to claim 8, wherein said screw feeder is a variable speed screw feeder.

10. A process for combining virgin blend material and reground tablet material, comprising feeding said reground tablet material to said virgin blend material for combining therewith, characterised by controlling the rate of feeding.

11. A process for preparing a tablet comprising combining virgin blend material and reground tablet material according to claim 10, and thereafter compressing the resulting composition into tablet form.

12. A process according to claim 10 or 11 wherein the rate of addition of reground tablet material is in the range 0.1 to 4.01 hr¹.

13. A process according to claim 10 or 11 wherein the rate of addition of reground tablet material is controlled by a screw feeder.

14. A process according to any of claims 10 to 13 wherein the reground tablet material and virgin blend material enter a chamber simultaneously.

15. A process according to claim 10 or 11 wherein the ratio of reground tablet material:virgin blend material does not exceed 1:10.

16. A process according to claim 10 or 11 wherein the reground tablet material and virgin blend material are of substantially the same composition.

17. A tablet obtainable by a process according to any one of claims 11 to 16.

18. An apparatus according to any one of claims 1 to 9 substantially as herein described with reference to the drawings and/or examples.

19. A process according to any one of claims 10 to 16, substantially as herein described with reference to the drawings and/or examples.
